(19) United States
(12) Patent Application Publication
(10) Pub. No.: US 2015/0042553 A1
(43) Pub. Date: Feb. 12, 2015

(54) DYNAMIC GPU FEATURE ADJUSTMENT BASED ON USER-OBSERVED SCREEN AREA

(71) Applicant: NVIDIA Corporation, Santa Clara, CA (US)

(72) Inventor: Andrew Mecham, Livermore, CA (US)

(73) Assignee: NVIDIA Corporation, Santa Clara, CA (US)

(21) Appl. No.: 13/963,523

(22) Filed: Aug. 9, 2013

(51) Int. Cl. G06F 3/01; G09G 5/00; G06F 3/14

(52) U.S. Cl. CPC G06F 3/013; G06F 3/1446; G09G 5/003
USPC 345/156

(57) ABSTRACT

An aspect of the present invention proposes a solution to allow a dynamic adjustment of a performance level of a GPU based on the user observed screen area. According to one embodiment, a user's focus in one or more display panels is determined. The GPU that performs rendering for that region and/or display panel will dynamically adjust (i.e., increase) the level of performance in response to the user's focus, whereas all other GPUs (e.g., the GPUs that perform rendering for other regions/display panels) will experience a reduced level of performance. According to such an embodiment, dynamically reducing the performance of GPUs outside of the area of focus can result in any one or more of a significant number of benefits, including lower power consumption rates, less processing, less (frequent) memory accesses, and reduced heat and noise levels

### BACKGROUND OF THE INVENTION

Graphics processing subsystems are used to perform graphics rendering in modern computing systems such as desktops, notebooks, and video game consoles, etc. Traditionally, graphics processing subsystems include one or more graphics processing units, or “GPUs,” which are specialized processors designed to efficiently perform graphics processing operations.

Some modern main circuit boards often include two or more graphics subsystems. For example, common configurations include an integrated graphics processing unit as well as one or more additional expansion slots available to add one or more discrete graphics units. Each graphics processing subsystem can and typically does have its own output terminals with one or more ports corresponding to one or more audio/visual standards (e.g., VGA, HDMI, DVI, etc.), though typically only one of the graphics processing subsystems will be running in the computing system at any one time.

Alternatively, other modern computing systems can include a main circuit board capable of simultaneously utilizing two or more GPUs (on a single card) or even two or more individual dedicated video cards to generate output to a single display. In these implementations, two or more graphics processing units (GPUs) share the workload when performing graphics processing tasks for the system, such as rendering a 3-dimensional scene. Ideally, two (or more) identical graphics cards are installed in a motherboard that contains a like number of expansion slots, set up in a “master-slave(s)” configuration. Each card is given the same part of the 3D scene to render, but effectively a portion of the work load is processed by the slave card(s) and the resulting image is sent through a connector called a GPU Bridge or through a communication bus (e.g., the PCI-express bus). For example, for a typical scene in a single panel-multi GPU configuration, the master card renders a portion (e.g., the top portion) of the scene while the slave card(s) render the remaining portions. When the slave card(s) are done performing the rendering operations to display the scene graphically, the slave card(s) send their respective outputs to the master card, which synchronizes and combines the produced images to form one aggregated image and then outputs the final rendered scene to the display device. In recent developments, the portions of the scene rendered by the GPUs may be dynamically adjusted, to account for differences in complexity of localized portions of the scene.

Even more recently, configurations featuring multi-GPU systems displaying output to multiple displays have been growing in popularity. In these systems, each GPU is individually coupled to a display device, with the operating system of the underlying computer system and its executing applications perceiving the multiple subsystems as a single, combined graphics subsystem with a total resolution equal to the sum of the GPU rendered areas. With the traditional multi-GPU techniques, each GPU renders a static partition of the combined scene and outputs the respective rendered part to its attached display. Typically, display monitors are placed next to each other (horizontally or vertically) to give the impression to the user of a single large display. Each display monitor thus displays a fraction (or “frame”) of the scene. Although each GPU renders its corresponding partition individually, a final synchronization among the GPUs is performed for each frame of the scene prior to the display (also known as a “present”) of the scene on the display devices.

Traditionally, each GPU will perform at equivalent, pre-selected performance levels. However, while playing games or other visually intensive sessions, a user of such a configuration will typically focus on one region of a single panel at any point in time, though the particular region and/or display panel may change frequently. For example, in many video games, the focus of a scene is typically the middle of the scene, although the user's attention may be directed to other portions of the scene from time to time. In these instances, running the GPUs of the displays that are not the user's focus at the same level as the display capturing the user's attention is unnecessary, and results in a gratuitous and inefficient use of computing resources.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An aspect of the present invention proposes a solution to allow a dynamic adjustment of a performance level of a GPU based on the user observed screen area. According to one embodiment, a user's focus in one or more display panels is determined. The GPU that performs rendering for that region and/or display panel will dynamically adjust (i.e., increase) the level of performance in response to the user's focus, whereas all other GPUs (e.g., the GPUs that perform rendering for other regions/display panels) will experience a reduced level of performance. According to such an embodiment, dynamically reducing the performance of GPUs outside of the area of focus can result in any one or more of a significant number of benefits, including lower power consumption rates, less processing, less (frequent) memory accesses, and reduced heat and noise levels.

In one embodiment, the user's observed area (e.g., focus) is determined constantly. Changes in the user's focus will result in a corresponding change in the performance levels of the corresponding displays. The performance levels may be dynamically increased or decreased by enabling or disabling (respectively) features. For example, a user focusing on a region or area in a middle display panel of three horizontally configured display panels may cause certain features to be enabled in the GPU of the middle display panel, with the same features disabled in the GPUs of the left and right display panels. When the user's focus changes to the left display panel, the system will detect the change, and automatically increase the performance level (e.g., by enabling certain, pre-designated features) in the left display panel, decrease the performance level in the central display panel, and maintain a lower performance level in the right most display panel.

According to some aspects, detection of the user's observed screen area may be performed by one or more eye tracking methods. In one embodiment, the graphical output produced by the GPUs may include stereo or 3-dimensional images, which require specialized optical devices (e.g., 3-D glasses) to fully experience. According to such an embodiment, video recording devices (e.g., small cameras) may be mounted to the optical devices which track the eye movements of the user. In other embodiments, the position, direction, and orientation of the 3-D glasses themselves may be tracked, either by a motion sensing or tracking device external to the optical device and/or with a similar device disposed on the optical devices.

According to another aspect of the present invention, a solution is proposed that allows computer resources savings via adjustment in a single display panel. According to an embodiment, user-focus tracking is performed to determine the particular regions of a single display panel. Regional performance levels are adjusted based on the determined focus. According these embodiments, the computer resource savings may be applied even to configurations with one display panel.

### BRIEF DESCRIPTION OF THE DRAWINGS

The accompanying drawings are incorporated in and form a part of this specification. The drawings illustrate embodiments. Together with the description, the drawings serve to explain the principles of the embodiments:

FIG. 1 depicts a flowchart of a process for dynamic performance adjustment in a multi-GPU, multi-display system based on user-observed screen area, in accordance with various embodiments of the present invention.

FIG. 2A depicts a first exemplary multi-display configuration with relative performance levels based on user-observed screen area, in accordance with various embodiments of the present invention.

FIG. 2B depicts a second exemplary multi-display configuration with relative performance levels based on user-observed screen area, in accordance with various embodiments of the present invention.

FIG. 2C depicts a third exemplary multi-display configuration with relative performance levels based on user-observed screen area, in accordance with various embodiments of the present invention.

FIG. 3A depicts a first exemplary on-screen graphical output indicative of relative performance levels based on user-observed screen area, in accordance with various embodiments of the present invention.

FIG. 3B depicts a second exemplary on-screen graphical output indicative of relative performance levels based on user-observed screen area, in accordance with various embodiments of the present invention.

FIG. 3C depicts a third exemplary on-screen graphical output indicative of relative performance levels based on user-observed screen area, in accordance with various embodiments of the present invention.

FIG. 4 depicts an exemplary optical device with eye-tracking capability, in accordance with embodiments of the present invention.

FIG. 5 depicts an exemplary computing system, upon which embodiments of the present invention may be implemented.

### DETAILED DESCRIPTION

Reference will now be made in detail to the preferred embodiments of the claimed subject matter, a method and system for the use of a radiographic system, examples of which are illustrated in the accompanying drawings. While the claimed subject matter will be described in conjunction with the preferred embodiments, it will be understood that they are not intended to limit these embodiments. On the contrary, the claimed subject matter is intended to cover alternatives, modifications and equivalents, which may be included within the spirit and scope as defined by the appended claims.

Furthermore, in the following detailed descriptions of embodiments of the claimed subject matter, numerous specific details are set forth in order to provide a thorough understanding of the claimed subject matter. However, it will be recognized by one of ordinary skill in the art that the claimed subject matter may be practiced without these specific details. In other instances, well known methods, procedures, components, and circuits have not been described in detail as not to obscure unnecessarily aspects of the claimed subject matter.

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer generated step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present claimed subject matter, discussions utilizing terms such as “storing,” “creating,” “protecting,” “receiving,” “encrypting,” “decrypting,” “destroying,” or the like, refer to the action and processes of a computer system or integrated circuit, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

Embodiments of the claimed subject matter are presented to include an image display device, such as a flat panel television or monitor, equipped with one or more backlights. These backlights may be programmed to provide illumination for pixels of the image display device. In certain embodiments, the position of the backlight(s) separates the pixels of the image display device into a plurality of regions, with each region being associated with the backlight closest in position to the region, and providing a primary source of illumination for the pixels in the region. In certain embodiments, illumination provided by neighboring backlights may overlap in one or more portions of one or more regions. In still further embodiments, the intensity of the illumination provided by a backlight decreases (attenuates) the greater the distance from the backlight.

### Exemplary Display Adjustment Based on User-Observed Area

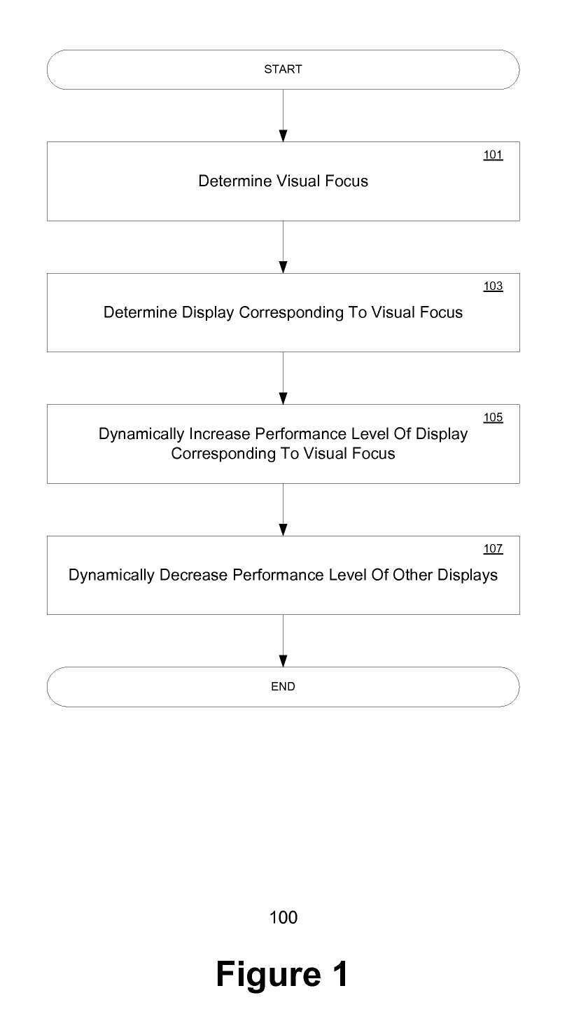

FIG. 1 illustrates a flowchart of an exemplary method 100 for dynamic performance adjustment in a multi-GPU, multi-display system based on user-observed screen area, in accordance with embodiments of the present invention. Steps 101-107 describe exemplary steps comprising the process 100 in accordance with the various embodiments herein described. According to various embodiments, steps 101-107 may be repeated continuously throughout a usage or viewing session. According to one aspect of the claimed invention, process 100 may be performed in, for example, a system comprising one or more graphics processing subsystems individually coupled to an equivalent plurality of display devices and configured to operate in parallel to present a single contiguous display area. These graphics processing subsystems may be implemented as hardware, e.g., discrete graphics processing units or “video cards,” or, in some embodiments, as virtual GPUs. For exemplary purposes, an embodiment featuring a three GPU configuration comprising three discrete video cards in a computing system is described herein, each video card being connected to a display device (e.g., a monitor, screen, display panel, etc.) placed in a horizontal configuration.

An exemplary scene to be displayed in the plurality of display devices is apportioned among the display devices corresponding to the portions of the scene to be rendered by each GPU for each scene. The portion of the scene displayed in a display device constitutes the “frame” of the corresponding display and GPU relationship. In an alternate embodiment, two or more graphics processing subsystems may be coupled to the same display device, and configured to render graphical output for portions of the same display frame. According to another aspect, process 100 may be implemented as a series of computer-executable instructions.

At step 401, a visual focus of the user is queried and determined. According to some aspects, detection of the user's visual focus may be performed by one or more eye tracking methods. In one embodiment, the graphical output produced by the GPUs may include stereo or 3-dimensional images, which require specialized optical devices (e.g., glasses) to fully experience. According to such an embodiment, video recording devices such as one or more small cameras may be mounted to the optical devices which track the eye movements of the user. These cameras may be further configured to process the eye movements to determine the visual focus of the user. Tracking of the user's visual focus may include determining a region or portion of a display panel the user is actively viewing, a line of sight of the user, or other indications of the user's visual attention or interest.

Alternately, the camera may be configured to transmit (e.g., over a wireless communications protocol) to a processor in the computing system in which the GPUs is comprised) to perform the analysis and to derive the particular region and/or display panel the user is focusing on. In other embodiments, the position, direction, and orientation of the 3 optical device itself may be tracked, either by a motion sensing or tracking device external to the optical device and/or with a similar device disposed on the optical devices. In further embodiments, the position, direction, and orientation of the optical device may be performed gyroscopically, using a gyroscope configured to determine and output the gyroscopic orientation to the computing system. Alternately, embodiments may use motion sensing devices in addition to, or in lieu of, gyroscopic positioning systems.

According to some embodiments, detection of the user's visual focus may be performed repeatedly (e.g., at short, pre-determined intervals) over the course of a use session. For example, the cameras mounted on the optical device may scan the user's eye for indication of movement or position, and send the resultant data to the computing system every millisecond ( 1/1000th of a second). Likewise, for embodiments wherein the movement and/or orientation of an optical device, gyroscopic and/or motion detection may performed, with the data transmitted, at similar intervals. While embodiments are described using exemplary eye tracking, gyroscopic, and/or motion sensing methods, it is to be understood that embodiments of the claimed invention are well suited for use with alternate implementations of these technologies in addition to those described herein.

At step 103, data corresponding to the determined visual focus (e.g., due to eye tracking, gyroscopic, and/or motion sensing methods) are analyzed to determine a display panel corresponding to the user's observed area. In multi-display configurations, for example, the specific panel may be determined. In single-display configurations, the particular region on the display panel may be determined. Analysis and processing of the data may be performed by a processor in the computing system. In some embodiments, eye tracking or positioning data may be received (e.g., wirelessly) in a wireless receiver coupled to the computing system. In some embodiments, the data may be processed by a processor comprised in the wireless receiver. In alternate embodiments, the data may be packaged, formatted, and forwarded to the a central processing unit of the computing system. Once the particular display panel (or display region) is identified, instructions are delivered to one or more GPUs of the system, in order to notify the GPUs to adjust their respective performance levels, as necessary.

At step 405, the performance level of the GPU corresponding to the display panel (or region) of the user's focus is adjusted, dynamically. Adjusting the performance level may comprise, in some embodiments, enabling certain features that affect the rendering of the graphical output. These features may include (but are not limited to):

anti-aliasing;

filtering;

dynamic range lighting;

de-interlacing;

hardware acceleration;

scaling; and

color and error correction.

Some or all of these features may be enabled in the GPU responsible for generating graphical output for the display panel (or region) corresponding to the user's visual focus, determined at step 103.

According to some embodiments, each GPU in the system may be configured to operate at one of a plurality of pre-configured, relative performance levels. These performance levels may correspond to clock frequencies and may include one or more features (described above). At higher performance levels, the increased clock frequencies may result in higher power consumption rates, more frequent memory access requests, and more heat fan noise. According to embodiments wherein the GPUs are configured to operate in one of multiple relative performance levels, the GPU of the display corresponding to the user's focus may be dynamically adjusted to the highest performance level at step 405. If no change in the user's area of focus is detected in steps 101 and 103, the GPU of the display panel corresponding to the user's focus remains operating at its previous (high) level.

At step 407, the performance level(s) of the one or more GPUs in the system that do not correspond to the display panel or region of the user's focus (as determined in step 103) are dynamically adjusted. In some instances, step 407 is performed simultaneously (or synchronously) with step 405. In an embodiment, the performance levels of these GPUs may be decreased, either by disabling certain features (e.g., the features listed above with respect to step 405). In further embodiments, the performance level may be decreased to a pre-configured performance level that may adjust the clock frequency of the GPU and disable one or more features. According to such embodiments, decreasing the performance level of a GPU will result in lower power consumption rates, likely fewer (or less frequent) memory access requests, and less heat and fan noise.

In some embodiments, the pre-configured performance level may be one of two or more discrete performance levels. In alternate embodiments, the performance level may correspond to a performance level in a range of incrementally (descending or ascending) performance levels. In multiple display configurations, the GPUs that are determined not to correspond to the display panel comprising the user's observed screen area may have their performance level decreased. This occurs when a GPU was operating at a higher performance level previously (e.g., the user's observed screen area corresponded to the display panel coupled to the GPU during the last iteration of the process, for example). For GPUs that were already operating at lower performance levels, no change may be necessary. According to some embodiments, certain applications may require a minimum performance level. In these instances, the performance level of a GPU may not be decreased below the minimum performance level required even if the user-observed screen area is determined to be in the display panel corresponding to a different GPU. Instead, the performance levels of the GPU may be maintained at the lowest performance level allowed for the application to run until the user's observed focus corresponds to the display panel of that GPU.

### Exemplary Display Configurations

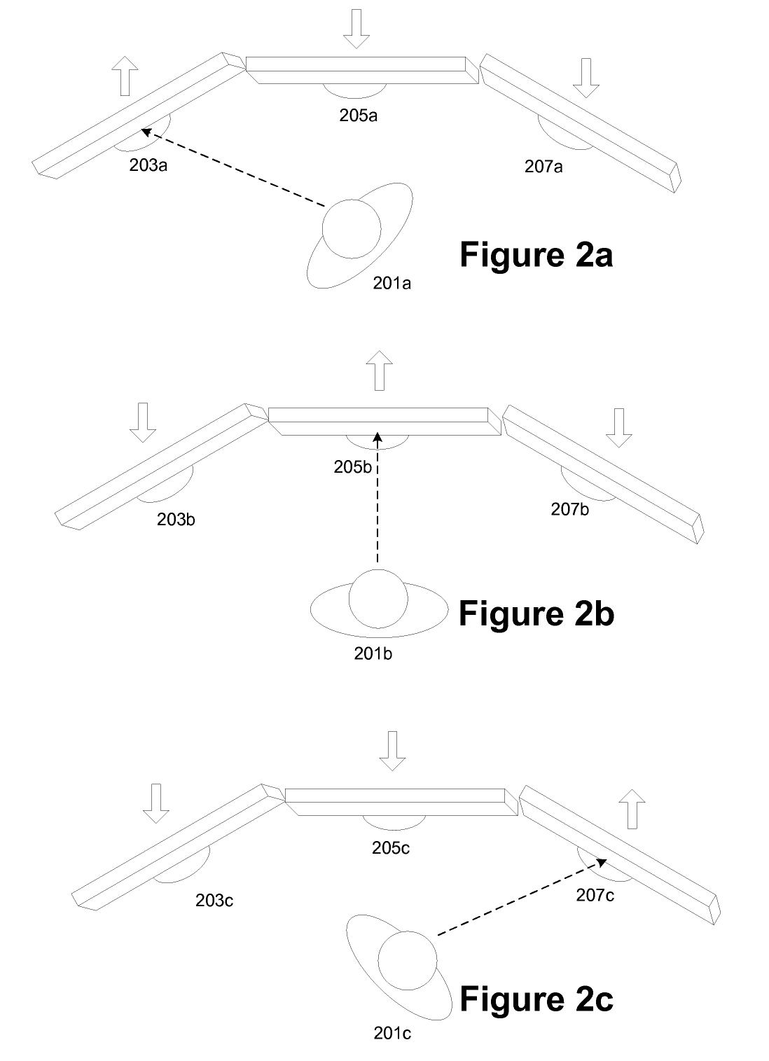

FIGS. 2A-2C depict exemplary multi-display configurations with relative performance levels based on user-observed screen area, in accordance with various embodiments of the present invention. As depicted in FIGS. 2a-2c, a three display panel configuration is provided, in a horizontal orientation. In such embodiments, each of the three display panels may be communicatively coupled to a graphical processing unit in the same computing system, and are used to simultaneously display graphical output of one or more applications.

As depicted in FIG. 2A, a user 201a is situated in front of each of three display panels (displays 203a, 205a, 207a). As depicted in FIG. 2A, the focus of the user 201a corresponds to a region in the left-most display (203a). In an exemplary scenario, the focus of the user 201a may be determined during a first iteration of the process 100. According to embodiments of the claimed invention, the performance level (e.g., resource consumption and/or features) of the GPU coupled to the left-most display panel (203a) may be dynamically adjusted in response to a determination of the user's current focus. As depicted, the performance level (indicated by the upwards-oriented vertical arrow) is increased in the GPU corresponding to the left-most display panel 203a. The performance levels (indicated by the downwards-oriented vertical arrow) of the GPUs coupled to the center (205a) and right (207a) display panels may also be adjusted in response to a determination of the user's current focus being at a different display panel. According to embodiments, when the user's focus does not change between focus queries (e.g., step 101 of the process 100), current performance levels may be maintained. For example, when the focus of the user 201a remains directed at the left panel 203a, the high performance level of the left panel and the low(er) performance levels of the center and right panels may be maintained.

As depicted in FIG. 2B, the focus of the user 201b now corresponds to a region in the center display (205b). In this exemplary scenario the focus of the user 201b may be determined by a second iteration of process 100. According to embodiments of the claimed invention, the performance level (e.g., resource consumption and/or features) of the GPU coupled to the center display panel (205b) is dynamically adjusted in response to a determination of the user's current focus. For example, the performance level (indicated by the upwards-oriented vertical arrow) may be increased in the GPU corresponding to the center most display panel 205b. In this exemplary scenario, the performance level (indicated by the downwards-oriented vertical arrow) of the GPU coupled to the left (203b) display panel is adjusted in response to a determination of the user's change in focus area, while the performance level of the GPU coupled to the right display panel remains at a low(er) performance level, though a change may be not be experienced between FIG. 2a to FIG. 2b.

As depicted in FIG. 2C, the focus of the user 201c now corresponds to a region in the right display panel (207c). In this exemplary scenario the focus of the user 201c may be determined by a third iteration of process 100. According to embodiments of the claimed invention, the performance level (e.g., resource consumption and/or features) of the GPU coupled to the center display panel (207c) is dynamically adjusted in response to a determination of the user's current focus. For example, the performance level (indicated by the upwards-oriented vertical arrow) is increased in the GPU corresponding to the right most display panel 207c. In this exemplary scenario, the performance level (indicated by the downwards-oriented vertical arrow) of the GPU coupled to the center (205c) display panel is adjusted in response to a determination of the user's change in focus area, while the performance level of GPU coupled to the left display panel remains at a low(er) performance level, though a change in that GPU may be not be experienced between FIG. 2B to FIG. 2C.

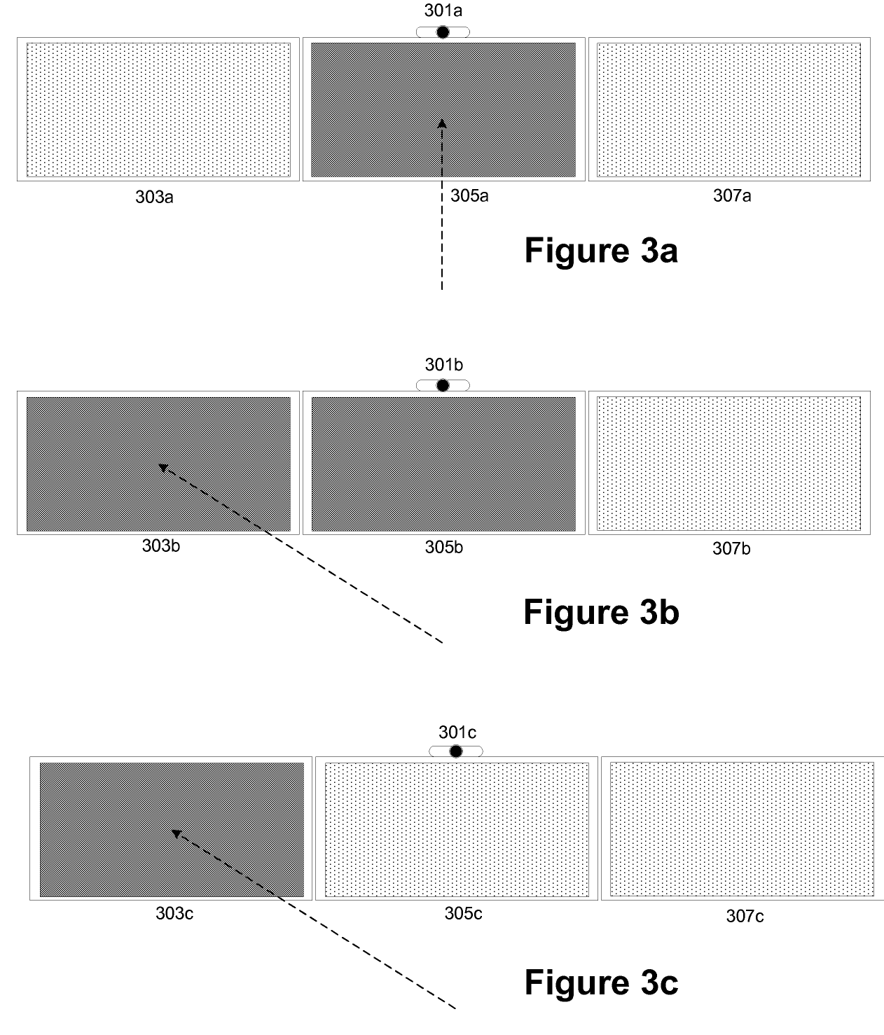

FIGS. 3A-3C depict exemplary on-screen graphical outputs indicative of relative performance levels based on user-observed screen area, in accordance with various embodiments of the present invention. As depicted in FIGS. 3A-3C, a three display panel configuration is provided, in a horizontal orientation. In such embodiments, each of the three display panels may be communicatively coupled to a graphical processing unit in the same computing system, and are used to simultaneously display graphical output of one or more applications.

As depicted in FIG. 3A, a tracking device 301a is situated proximate to three display panels (displays 303a, 305a, 307a). In some embodiments, the tracking device 301a may comprise a wireless receiver device configured to receive eye tracking data wirelessly from an optical device worn by the user (and captured by cameras, for example). The tracking device 301a may be further configured to process the eye tracking data to determine the display panel corresponding to the user-observed area. Alternately, the tracking device 301a may be configured to forward the data to the processor of the computing system for analysis. In still other embodiments, the tracking device 301a may be configured to track and/or analyze gyroscopic motion of the optical device or the user's eyes/face. In still further embodiments, the tracking device 301a may be configured to determine, via motion sensing processes, movement, position, and orientation of the user's face, eyes, or an optical device worn by the user.

As depicted in FIG. 3A, the focus of a user may be determined (e.g., by the tracking device 301a) to correspond to a region in the center display (305a). In an exemplary scenario, the focus of the user may be determined during a first iteration of the process 100. According to embodiments of the claimed invention, the performance level (e.g., resource consumption and/or features) of the GPU coupled to the center display panel (305a) may be dynamically adjusted in response to a determination of the user's current focus. As depicted, the performance level (indicated by the higher graphical saturation) is increased in the GPU corresponding to the center display panel 305a. The performance levels (indicated by the lower graphical saturation) of the GPUs coupled to the left (303a) and right (307a) display panels may also be adjusted in response to a determination of the user's current focus being at a different display panel. As described above with respect to FIG. 2A, when the user's focus does not change between focus queries (e.g., step 101 of the process 100), current performance levels may be maintained. For example, when the focus of the user is determined by the tracking device 301a to be directed at the center panel 305a in the next iteration of process 100, the high performance level of the center panel and the low(er) performance levels of the left and right panels may be maintained.

As depicted in FIG. 3B, a change in the focus of the user has been detected (via a determination from the tracking device 301b, for example) to correspond to the left display panel 303b. In this exemplary scenario the focus of the user may be determined by the tracking device 301b during a second iteration of process 100. According to embodiments of the claimed invention, the performance level (e.g., resource consumption and/or features) of the GPU coupled to the left display panel (303b) is dynamically adjusted (increased) in response to a determination of the user's current focus. An increase in performance level (indicated by the higher graphical saturation) is experienced in the GPU corresponding to the left display panel 303b, while no change may be experienced in the right display panel 307b).

According to some embodiments, to account for rapid changes in user-focus, a time-delay may be implemented for adjustments in the GPUs coupled to display panels which do not correspond to the display panel of the user's current focus. In this exemplary scenario, the performance level of the GPU coupled to the user's previous observed area (e.g., center display panel 305b) remains at a high level after the user's focus has been detected (via tracking device 301b) to have changed to a different display panel 303b. The performance level may persist at the high level until a pre-determined amount of time has elapsed and the user's focus has not been detected to have changed back to the center display during the lapse of time. In embodiments where the performance level comprises one of a multiple discrete levels, the performance level may not be adjusted (decreased) until the entire duration has elapsed. In embodiments where the performance level corresponds to one of a range of performance levels, the performance level may incrementally decrease during the pre-determined amount of time, in lieu of experiencing a single, drastic drop in performance.

FIG. 3C depicts the state of the performance levels in the display panels (303c, 305c, 307c) after a pre-determined period of time has elapsed after a single change in user-observed screen area (focus). As depicted in FIG. 3C, no change in the focus of the user has been determined (by tracking device 301c). In this exemplary scenario, the focus of the user has been determined to remain in the display panel 303c following a first detected change from the center display panel 305c (depicted as 305a in FIG. 3A). The performance level of the center display 305c is adjusted once the pre-determined duration of time has lapsed following the detected change in focus. As indicated by the (lack of) graphical saturation, the performance level of the center display 305c may be decreased, either by disabling certain features or lowering the resource consumption rate in the GPU coupled to the center display 305c. As depicted in FIG. 3C, since no further change in the user's focus was determined, no change may be experienced in the right display panel 307b).

While FIGS. 2A-2C and 3A-3C have been depicted with three display panels in a horizontal configuration, embodiments of the present invention are well-suited to varying numbers of display panels, and/or configurations. In single display panel configurations, detection may be performed for particular regions of the display panel, with each region being graphically rendered by a GPU.

### Exemplary Optical Device

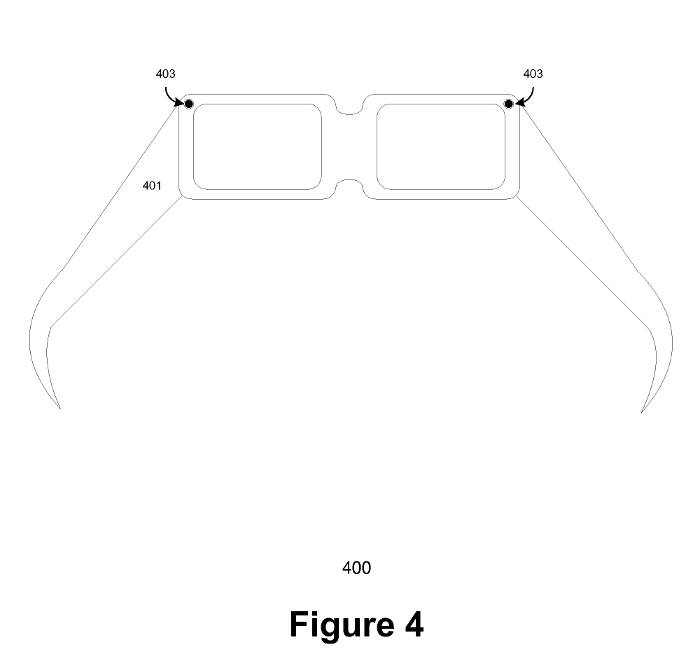

FIG. 4 depicts an exemplary optical device 400 with eye-tracking capability, in accordance with embodiments of the present invention. In some embodiments, the graphical output rendered by the GPUs and displayed in the display devices (e.g., configurations depicted in FIGS. 2A-3C) may be output in stereoscopically, e.g., as a three-dimensional display. In such instances, the optical device 400 may comprise a pair of three-dimensional glasses. Alternately, the optical device 400 may be implemented as glasses with computing and/or data transfer capabilities. According to an embodiment, optical device 400 may be used to track a user's observed focus area (e.g., in one of a plurality of display panels, or in one of a plurality of regions in a display panel). As depicted in FIG. 4, optical device 400 may track of the user's observed focus area by tracking the movement of the user's eyes via imaging devices (e.g., cameras 403). As shown, these cameras 403 may be mounted on the interior of the optical device 400. Alternately, the optical device may include gyroscopic and/or motion detection (e.g., an accelerometer) devices. According to embodiments, the optical device 400 may transfer (via a wireless stream, for example) user eye-tracking data to a receiver device (e.g., tracking device 301a, 301b, 301c in FIG. 3A-3C), coupled to the computing system in which the GPUs are comprised.

### Exemplary Computing System

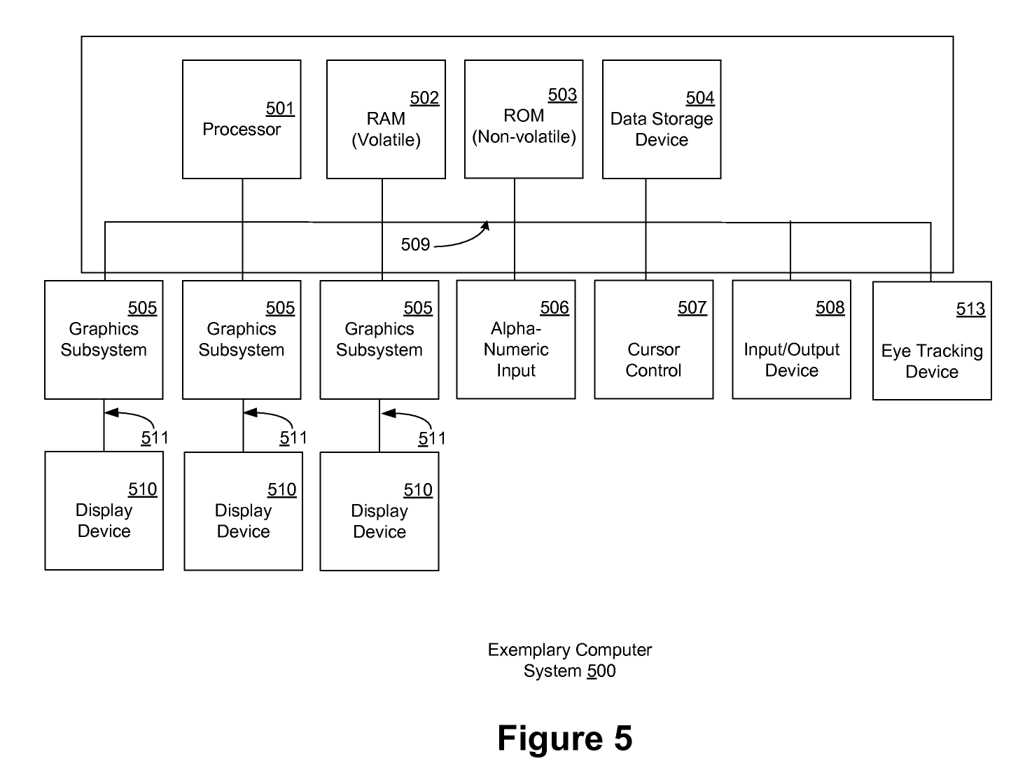

As presented in FIG. 5, an exemplary system for implementing embodiments includes a general purpose computing system environment, such as computing system 600. In its most basic configuration, computing system 500 typically includes at least one processing unit 501 and memory, and an address/data bus 509 (or other interface) for communicating information. Depending on the exact configuration and type of computing system environment, memory may be volatile (such as RAM 502), non-volatile (such as ROM 503, flash memory, etc.) or some combination of the two. Computer system 500 may also comprise one or more graphics subsystems 505 for presenting information to the computer user, e.g., by displaying information on attached display devices 510, connected by a plurality of video cables 511. As depicted in FIG. 5, three graphics subsystems 505 are individually coupled via video cable 511 to a separate display device 510. In one embodiment, process 100 for dynamically adaptive performance adjustment may be performed, in whole or in part, by graphics subsystems 505 and displayed in attached display devices 510.

Additionally, computing system 500 may also have additional features/functionality. For example, computing system 500 may also include additional storage (removable and/or non-removable) including, but not limited to, magnetic or optical disks or tape. Such additional storage is illustrated in FIG. 5 by data storage device 504. Computer storage media includes volatile and nonvolatile, removable and non-removable media implemented in any method or technology for storage of information such as computer readable instructions, data structures, program modules or other data. RAM 502, ROM 503, and data storage device 504 are all examples of computer storage media.

Computer system 500 also comprises an optional alphanumeric input device 506, an optional cursor control or directing device 507, and one or more signal communication interfaces (input/output devices, e.g., a network interface card) 508. Optional alphanumeric input device 506 can communicate information and command selections to central processor 501. Optional cursor control or directing device 507 is coupled to bus 509 for communicating user input information and command selections to central processor 501. Signal communication interface (input/output device) 508, which is also coupled to bus 509, can be a serial port. Communication interface 509 may also include wireless communication mechanisms. Using communication interface 509, computer system 500 can be communicatively coupled to other computer systems over a communication network such as the Internet or an intranet (e.g., a local area network), or can receive data (e.g., a digital television signal).

According to embodiments of the present invention, novel solutions and methods are provided for dynamically adjusting feature enablement and performance levels in graphical processing units based on user-observed screen area. By dynamically adjusting features and performance levels in graphical processing units that render graphical output for display to display panels that do not correspond to the user's current area of focus, resource consumption and adverse side effects of high levels of processing such as noise and heat can be substantially decreased with little or no detrimental effect to the user's viewing experience.

In the foregoing specification, embodiments have been described with reference to numerous specific details that may vary from implementation to implementation. Thus, the sole and exclusive indicator of what is the invention, and is intended by the applicant to be the invention, is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A system, comprising:
a plurality of display panels;
a plurality of graphical processing units (GPUs) coupled to the plurality of display panels and configured to render a graphical output to display on the plurality of display panels;
a mechanism operable to determine a visual focus point of a user, the visual focus point corresponding to a position in a first display panel in the plurality of display panels; and
wherein a plurality of performance levels corresponding to the plurality of GPUs are dynamically adjusted based on the position of the visual focus point of the user.

2. The system according to claim 1, wherein a performance level of the GPU coupled to the first display panel is increased while the visual focus point the user corresponds to a position in the first display panel.

3. The system according to claim 2, wherein a rate of power consumption of the GPU coupled to the first display panel is increased when the performance level of the GPU is increased.

4. The system according to claim 1, wherein performance levels of the GPUs not coupled to the first display panel are dynamically decreased while the visual focus point the user corresponds to a position in the first display panel.

5. The system according to claim 4, wherein rates of power consumption of the GPUs not coupled to the first display panel are decreased when the performance level of the GPU coupled to the first display panel is increased.

6. The system according to claim 1, wherein the mechanism comprises a plurality of camera devices.

7. The system according to claim 6, wherein the plurality of camera devices are operable to continuously track an eye movement of the user to determine the visual focus of the user.

8. The system according to claim 6, further comprising an optical device operable to be worn by the user, wherein the plurality of camera devices is disposed on the optical device.

9. The system according to claim 8, wherein the optical device comprises a pair of glasses.

10. The system according to claim 9, wherein the mechanism is operable to perform a gyroscopic determination of an orientation of the optical device relative to the plurality of display panels.

11. The system according to claim 1, wherein the plurality of performance levels corresponding to the plurality of GPUs are dynamically adjusted in response to a change in the position of the visual focus point of the user.

12. A method comprising:
determining, in a plurality of displays, a line of sight of a viewer;
determining the visual focus of the viewer corresponds to a first display of the plurality of displays;
dynamically increasing a performance level of a first graphical processing unit (GPU) in response to the determining the visual focus of the viewer corresponds to the first display, the dynamically increase being maintained while the visual focus of the viewer corresponds to the first display, the first graphical processing unit being used to render graphical output displayed in the first display; and
dynamically decreasing a performance level of at least one GPU in response to the dynamically increasing the performance level of first GPU,
wherein the at least one GPU is coupled to at least one display of the plurality of displays that is not the first display and is used to render graphical output displayed in the at least one display.

13. The method according to claim 12, further comprising:
detecting a change in the visual focus of the viewer;
determining the change in the visual focus of the viewer corresponds to a second display of the plurality of displays, the second display comprising a different display than the first display;
dynamically increasing a performance level of a second GPU in response to the determining the change in the visual focus of the viewer corresponds to the second display while the visual focus of the viewer corresponds to the second display, wherein the second GPU is coupled to the second display and is used to render graphical output displayed in the second display; and
dynamically decreasing the performance level of the first GPU in response to the dynamically increasing the performance level of the second GPU.

14. The method according to claim 12, wherein the dynamically decreasing the performance level of the first GPU is performed after a pre-determined period of time following the determining the change in the visual focus of the viewer.

15. The method according to claim 14, wherein the dynamically decreasing the performance level of the first GPU is performed if the visual focus of the viewer is not determined to again correspond to the first display during the pre-determined period of time.

16. The method according to claim 12, wherein the dynamically increasing the performance level of the first GPU comprises enabling a plurality of features in the first.

17. The method according to claim 12, wherein the dynamically decreasing the performance level of the at least one GPU comprises disabling a plurality of features in the at least one GPU used to render graphical output displayed in the at least one display of the plurality of displays that is not the first display.

18. The method according to claim 12, wherein the determining a visual focus of a viewer comprises repeatedly tracking a movement of a plurality of eyes of the viewer relative to the plurality of displays.

19. The method according to claim 18, wherein the tracking a movement of a plurality of eyes of the viewer comprises repeatedly scanning the position of the eyes of the viewer via a plurality of camera devices comprised in an optical device worn by the viewer.

20. The method according to claim 19, wherein the repeatedly tracking a movement of a plurality of eyes of the comprises repeatedly scanning, via a camera device disposed proximate to at least one panel of the plurality of display panels.

21. The method according to claim 12, wherein determining a visual focus of a viewer comprises gyroscopically determining an orientation of an optical device worn by the user relative to the plurality of displays.

22. A computer readable storage medium comprising program instructions embodied therein, the program instructions comprising:
instructions to determine, in a plurality of displays, a line of sight of a viewer;
instructions to determine the visual focus of the viewer corresponds to a first display of the plurality of displays;
instructions to dynamically increase a performance level of a first graphical processing unit (GPU) in response to the determining the visual focus of the viewer corresponds to the first display while the visual focus of the viewer corresponds to the first display, the first graphical processing unit being used to render graphical output displayed in the first display; and
instructions to dynamically decrease a performance level of at least one GPU in response to the dynamically increasing the performance level of first GPU,
wherein the at least one GPU is coupled to at least one display of the plurality of displays that is not the first display and is used to render graphical output displayed in the at least one display.
